(19) United States
(12) Patent Application Publication
(10) Pub. No.: US 2013/0110609 A1
(43) Pub. Date: May 2, 2013

(54) METHOD AND APPARATUS FOR CONTROLLED DATA SHARING FOR VENDOR LOYALTY PROGRAM EXECUTION

(71) Applicants: Wei Yeh Lee, New York, NY (US); Sergey Boldyrev, Soderkulla (FI); Ian Justin Oliver, Soderkulla (FI)

(72) Inventors: Wei Yeh Lee, New York, NY (US); Sergey Boldyrev, Soderkulla (FI); Ian Justin Oliver, Soderkulla (FI)

(21) Appl. No.: 13/538,158

(22) Filed: Jun. 29, 2012

Related U.S. Application Data
(60) Provisional application No. 61/503,170, filed on Jun. 30, 2011.

(51) Int. Cl. G06Q 30/02

(52) U.S. Cl. CPC G06Q 30/0226
USPC 705/14.27

(57) ABSTRACT

An approach is provided for of enabling users to control the sharing of user profile information with respect to vendors based on user participation in, or value derived from, one or more vendor loyalty programs. A cross vendor management platform processes and/or facilitates a processing of user profile information to identify loyalty program information associated with at least one user. The user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

### RELATED APPLICATIONS

This application claims benefit of the earlier filing date under 35 U.S.C. §119(e) of U.S. Provisional Application Ser. No. 61/503,170 field Jun. 30, 2011, entitled “Method and Apparatus for Controlled Data Sharing for Vendor Loyalty Program Execution,” the entirety of which is incorporated herein by reference.

### BACKGROUND

Today's Internet ready wireless communication devices such as mobile phones, personal data assistants (PDAs), laptop computers and the like, make on-demand access to information convenient for users. The devices are configured to employ various methods of connectivity for both accessing and storing data provided by one or more content providers or other devices for individual or group retrieval. This accessibility does not come without a cost, however, as users still have little control over how their personal profile information is collected, obtained and accessed by vendors or other third party channels. For example, when a user visits a webpage of a vendor they are affiliated with by way of a loyalty program, information regarding the user's habits, preferences, purchase history, demographics, contact information and other personal data is maintained at the discretion of the vendor. In exchange for this level of access to the user's information, the vendor offers the user various incentives such as prizes, points and discounts. Unfortunately, the user cannot themselves mandate the terms of sharing of their personal information respective to the vendor. Still further, the users are bound to the terms of use of the incentives as set by the vendor, and therefore, have no ability to maximize or leverage the use of their accumulated incentives across vendors while still maintaining control over the integrity and sharing of their personal information.

### SOME EXAMPLE EMBODIMENTS

Therefore, there is a need for an approach for enabling users to control the sharing of user profile information with respect to vendors based on user participation in, or value derived from, one or more vendor loyalty programs.

According to one embodiment, a method comprises processing and/or facilitating a processing of user profile information to identify loyalty program information associated with at least one user. The user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of user profile information to identify loyalty program information associated with at least one user. The user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

According to another embodiment, a computer-readable storage medium carries one or more sequences of one or more instructions which, when executed by one or more processors, cause, at least in part, an apparatus to process and/or facilitate a processing of user profile information to identify loyalty program information associated with at least one user. The user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

According to another embodiment, an apparatus comprises means for causing, at least in part, a signing of one or more computation closures of at least one functional flow. The apparatus also comprises means for processing and/or facilitating a processing of user profile information to identify loyalty program information associated with at least one user. The user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling users to control the sharing of user profile information with respect to vendors based on user participation in, or value derived from, one or more vendor loyalty programs, according to one embodiment;

FIG. 2 is a diagram of the components of a cross vendor management platform, according to one embodiment;

FIGS. 3A and 3B are flowcharts of processes for enabling users to control the sharing of user profile information with respect to vendors based on user participation in, or value derived from, one or more vendor loyalty programs, according to various embodiment;

FIGS. 4A-4D are diagrams of user interfaces representing various functional flows for enabling the control and sharing of user profile information, according to various embodiments;

FIGS. 5A and 5B are diagrams of distribution of controlled user profile information and energy optimization in multi-level computational architecture, according to various embodiments;

FIGS. 6A-6C are diagrams of user interfaces utilized in the processes of FIGS. 3A and 3B, according to various embodiments;

FIGS. 7A-7B are diagrams of computation distribution among devices, according to various embodiments;

FIG. 8 is a diagram showing a process as a combination of primitive computation closures, according to one embodiment;

FIG. 9 is a diagram of process distribution from a device to another device, according to one embodiment; and

FIG. 10 is a diagram of computation closure allocation/mapping, according to one embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for enabling users to control the sharing of user profile information with respect to vendors based on user participation in, or value derived from, one or more vendor loyalty programs are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As will be discussed, a computation closure may include, for example, a particular computation procedure together with relations and communications among various processes including passing arguments, sharing process results, selecting results provided from computation of alternative inputs, flow of data and process results, etc. The computation closures (e.g., a granular reflective set of instructions, data, and/or related execution context or state) provide the capability of slicing of computations for processes and transmitting the computation slices between devices, infrastructures and information sources.

A cloud or information space may include, for example, an aggregated set of information and computation closures from different sources. This multi-sourcing is very flexible since it accounts and relies on the observation that the same piece of information or computation can come from different sources. Furthermore, multi-sourcing is well suited for enabling the sharing and exchange of information or computations within a distributed environment. In one embodiment, information and computations within the cloud are represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information and computations that is implemented in web resources; using a variety of syntax formats. Although various embodiments are described with respect to clouds, it is contemplated that the approach described herein may be used with other structures and conceptual description methods used to create distributed models of information and computations.

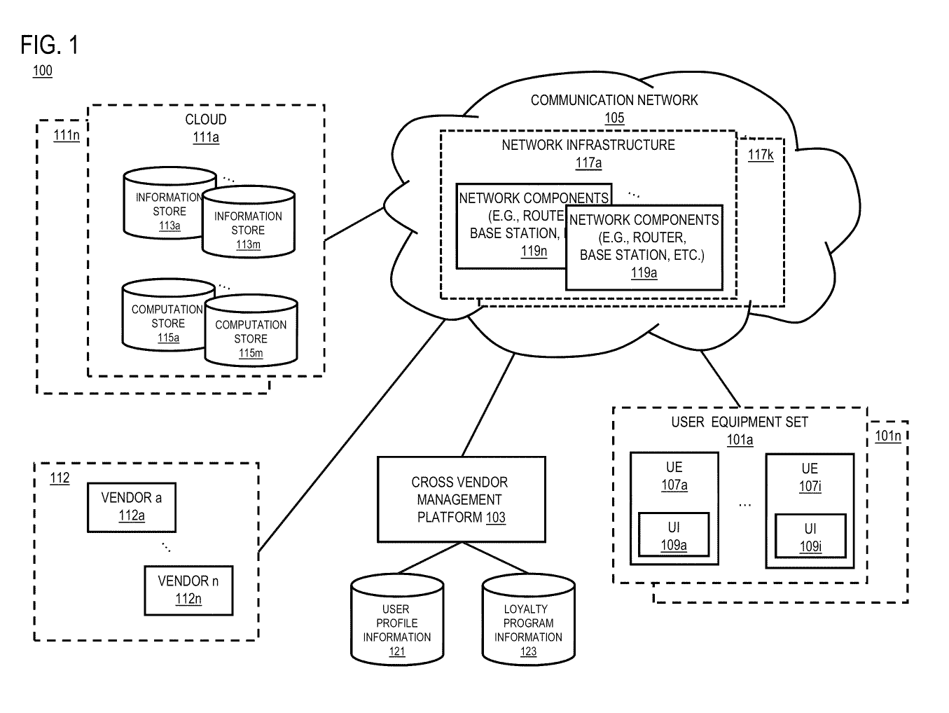

FIG. 1 is a diagram of a system capable of enabling users to control the sharing of user profile information with respect to vendors based on user participation in, or value derived from, one or more vendor loyalty programs, according to one embodiment. As previously described, a cloud environment consists of information and computation resources each consisting of several distributed devices that communicate information and computation closures (e.g. RDF graphs) via a shared memory. A device within a cloud environment, such as by virtue of a login and network access process, may store computation closures locally in its own memory space or publish computation closures on a globally accessible environment within the cloud. In the first case, the device is responsible for any process needed for combination or extraction of computations, while in the second case the processes can be conducted by the globally accessible environment which includes the device. The device can utilize the resources of the architectural infrastructure level, for example for energy saving, without having to access the cloud level, if energy cost is lower at the infrastructure level. Alternatively, a device may have direct computational closure connectors to the cloud level, where devices are more tightly linked to the cloud environment for energy saving purposes.

The basic concept of cloud computing technology provides access to distributed computations for various devices within the scope of the cloud, in such a way that the distributed nature of the computations is hidden from users and it appears to a user as if all the computations are performed on the same device. The cloud computing also enables a user to have control over computation distribution by transferring computations between devices that the user has access to. For example, a user may want to transfer computations among work devices, home devices, and portable devices, other private and public devices, etc. Current technologies enable a user of a mobile device to manipulate contexts such as data and information via the elements of a user interface of their user equipment. However, distribution of computations and processes related to or acting on the data and information within the cloud is typically controlled by the system. In other words, a cloud in general does not provide a user (e.g., an owner of a collection of information distributed over the information space) with the ability to control distribution of related computations and processes of, for instance, applications acting on the information. For example, a contact management application that processes contact information distributed within one or more clouds generally executes on a single device (e.g., with all processes and computations of the application also executing on the same device) to operate on the distributed information. In some cases (e.g., when computations are complex, the data set is large, etc.), providing a means to also distribute the related computations in addition to the information is advantageous.

This goal is achieved by introduction of the capability to construct, distribute, and aggregate computations as well as their related data. More specifically, to enable a user of a cloud (e.g., a mobile device user, an application developer, etc.) who connects to the cloud via one or more devices, to distribute computations among the one or more user devices or other devices with access to the cloud, each computation is deconstructed to its basic or primitive processes or computation closures. Once a computation is divided into its primitive computation closures, the processes within or represented by each closure may be executed in a distributed fashion and the processing results can be collected and aggregated into the result of the execution of the initial overall computation.

In one embodiment, cloud computing enables users to interact with other devices and execute one or more information and computation closures within the boundaries of the cloud. Within the cloud, devices may interact based on locally defined semantics that set the basis for their interaction within the cloud 111. Conventional means of accessing information, however, is limited given that the semantics and associated access privileges are established by others. For example, users have little to no control over how much personal information is gathered about them as they navigate a vendor's website to explore product offerings, consider purchases, update their preferences, etc. Furthermore, because the semantics of the engagement is set by the vendor, user's have little ability to control how information is shared by the vendor with others (e.g., affiliates), how they'd like product offerings to be presented to them as they navigate the site, terms and conditions favorable to them as they explore, etc.

Some consumers take advantage of loyalty programs as a means of being offered incentives or special privileges with the vendor, and thus, perhaps being granted more features, customization options or choices than other consumers. Typically, the privileges are based on the accumulation of loyalty points, which may be gained based on purchases made, by way of membership privileges, as a result of years of patronage, or other means. Nonetheless, the consumer is still beholden to the terms and conditions as set forth by the vendor as it comes to the tracking and usage of their personal information with respect to the program, how they may use or redeem their accumulated points or other gained incentives, etc.

Therefore, there is a need for enabling users of devices to maximize or leverage the use of their accumulated loyalty program incentives across vendors while maintaining control over the integrity and sharing of their personal information. To address this problem, a system 100 of FIG. 1 introduces the capability leverage a cloud computing environment for enabling storage of a user's profile information, i.e., as a personal profile stronghold. By way of this approach, users may reliably control the sharing, accessing and dissemination of their personal profile information (or portions thereof) with vendors and others within the context of the cloud. The user profile information may be generated as a scalable data structure, wherein one or more user criteria may be imposed for affecting which elements of the data structure are available to devices within the information space. In addition to limiting distribution of the profile information, one or more rules of distribution of the information may also be adapted or customized to affect distribution.

In addition, the system 100 presents a loyalty program value accumulation exchange mechanism, wherein users may quantify the value of their accumulated incentives (e.g., loyalty points) and leverage the use of said incentives with other vendors. For example, an airline company may issue frequent flyer miles for those who are registered with the airline's loyalty program, wherein the miles are restricted to use with that airline only. A cross vendor management platform 103, however, may be configured to access the profile information and frequent flyer information to enable a consumer to dynamically apply their miles at a competing airline. Hence, users are able to utilize points for a narrowly defined vendor loyalty programs across multiple different vendors by virtue of a personalized, secure, cloud infrastructure that also enables selective control over data sharing. Table 1 below summarizes various characteristics of the system 100 for supporting cross vendor exchange and transfer versus traditional vendor-to-user interaction schemes:

TABLE 1

| Secure, cross vendor value exchange model | Traditional vendor-to-user value model |
|---|---|
| Relationships are be voluntary; at the | Relationship is mandated and overseen by the |
| discretion of the device user/consumer | vendor |
| Consumers enter relationships with vendors | Consumers enter relationships with vendors as |
| as independent actors. | dependent actors |
| Consumers are the points of integration for | The vendor is the point of integration and |
| their own data, i.e., integration is achieved by | aggregation of the consumers data |
| way of a personal profile stronghold as | |
| implemented over an information space. | |
| Consumers control the data they generate and | Vendors dictate the data that is to be shared; |
| gather; able to share data selectively, | user selectivity is limited to the preferences of |
| voluntarily, and control the terms of its use; | the vendor; the vendor controls the terms of its |
| consumers must be able to assert their own | use (e.g., customer MUST accept a “Use |
| terms of engagement and service | Agreement”) |
| Consumers express their demands and | Vendor binds the user/consumer to a “Use |
| intentions outside of any one company's | Agreement”; exclusive offers and incentives |
| control | are presented at the discretion of the vendor |

As shown in FIG. 1, the system 100 comprises sets 101a-101n of user equipments (UEs) 107a-107i having connectivity to the distributed cross vendor management platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 107a-107i can support any type of interface to the user (such as “wearable” circuitry, etc.).

In one embodiment, the UEs 107a-107i are respectively equipped with one or more user interfaces (UI) 109a-109i. Each UI 109a-109i may consist of several UI elements (not shown) at any time, depending on the service that is being used. UI elements may be icons representing user contexts such as information (e.g., music information, contact information, video information, etc.), functions (e.g., setup, search, etc.) and/or processes (e.g., download, play, edit, save, etc.). These contexts may require certain sets of media dependent computational closures, which may affect the service, for example the bit error rate, etc. Additionally, each UI element may be bound to a context/process by granular distribution. In one embodiment, granular distribution enables processes to be implicitly or explicitly migrated between devices, computation clouds, and other infrastructure. Additionally, a UE 107a-107i may be a mobile device with embedded Radio Frequency (RF) tag system of device to device connections such that computational operations and content can be locally transmitted among devices.

While not shown, respective UE 107A-107i may include one or more embedded sensors for collecting/sensing information. By way of example, a location sensor may be employed for tracking location information and geo-spatial data, while a motion sensor may be used to track device movement. This information may be collected and subsequently analyzed by the cross vendor management platform 103 for selectively accessing and retrieving user profile information 121 pertaining to a user having access to the computation cloud 111a-111n. The sensors may be relied upon, for example, to execute a functional flow associated with the one or more information spaces (e.g., clouds 111a-111n). A functional flow may include one or more computation closures together with one or more distribution paths that represent the distribution of computation closures. The computation closures may be signed automatically or manually at development time, at run-time or a combination thereof.

In one embodiment, process distribution can be initiated for example by means of unicast (e.g., to just another device) or multicast (e.g., to multiple other devices). For example one UE 107 may communicate with many infrastructures (or many components of many infrastructures), while many nodes of infrastructures may communicate with multiple clouds. Additionally, process distribution may be triggered via gesture recognition, wherein the user preselects a particular set of UI elements and makes a gesture to simulate “pouring” the selected UE elements from one device to another. In other embodiments, process distribution may be initiated automatically without direct user involvement and based on default setup by the manufacturer of the UE 107a-107i, previous setup by the user of the UE, default setup in an application activated on or associated with a UE 107a-107i, or a combination thereof.

As seen in FIG. 1, a user of UEs 107a-107i may own, use, or otherwise have access to various pieces of information and computations distributed over one or more computation clouds 111a-111n in information stores 113a-113m and computation stores 115a-115m where each of the one or more computation spaces 115a-115m include multiple sets of one or more computation closures. In one embodiment, the user may be an application developer that uses a UE 107a-107i to connect to the infrastructure and the cloud not only for accessing the services provided for end users but also for activities such as developing, distributing, processing, and aggregating various computations.

In one embodiment, the communication network 105 consists of one or more infrastructures 117a-117k wherein each infrastructure is a designed communication system including multiple components 119a-119n. The components 119a-119n include backbones, routers, switches, wireless access points, access methods, protocols, etc. used for communication within the communication network 105 or between communication network 105 and other networks.

In one embodiment, the UEs 107a-107n may interact with one or more different vendors 112 by way of the cross vendor management platform 103. The interaction may include the accessing of a respective vendor 112a-112n website. The interaction with the vendor may also be based on user participation in a loyalty program with the vendor, wherein the user has associated loyalty program information for representing their participation in the program. Loyalty program information 123 is maintained in association with user profile information 121 of the user. By way of example, the loyalty program information 123 may include data for indicating a length of time of user participation in the loyalty program, a number of purchases made, a number of loyalty points and incentives garnered, a monetary value associated with the points and incentives, purchasing preferences and patterns, incentive redemption schemes, membership or rewards level, and other information. The cross vendor management platform 103 may retrieve such information from one or more information stores 113a-113n as maintained by the user cloud 111a-111n.

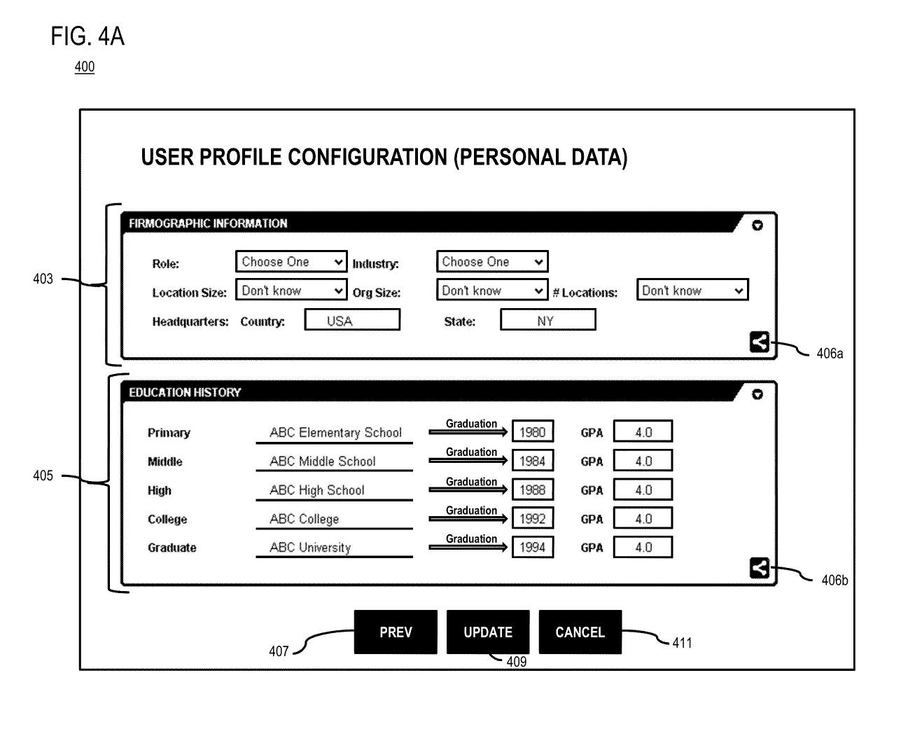

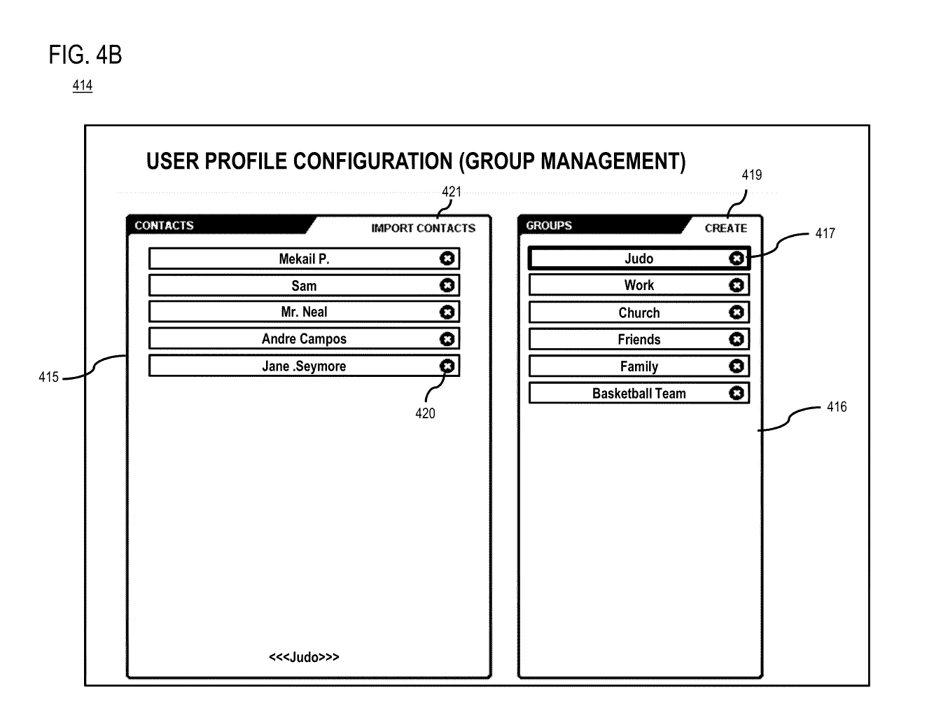

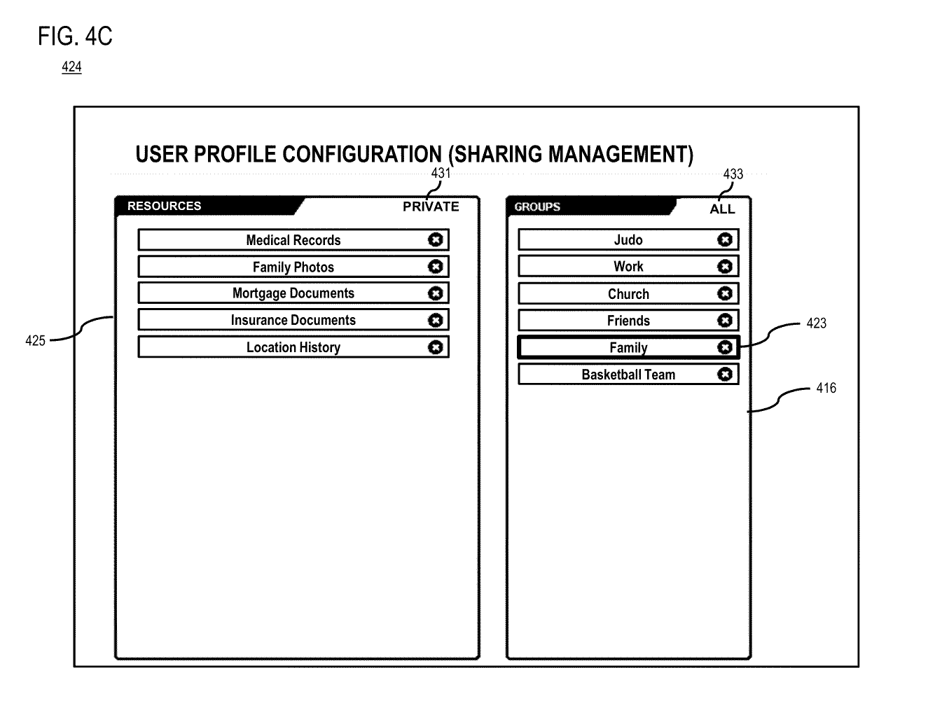

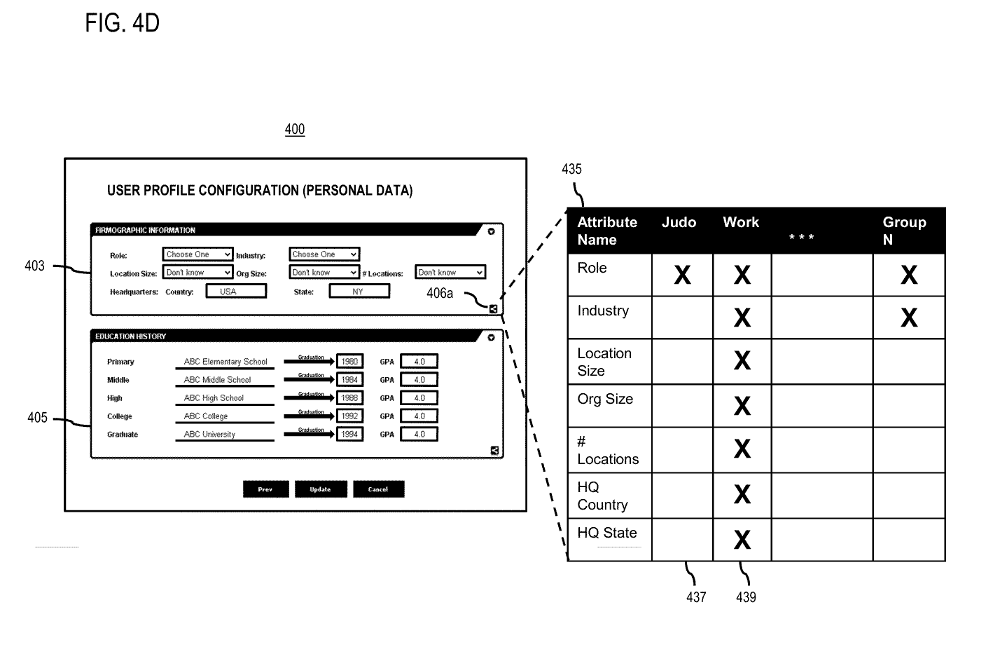

It is noted that retrieval or access to the loyalty program information 123 and user profile information via the cloud 111 limits distribution of the information to within the cloud. Hence, by way of example, one or more computations may be executed for limiting the access of vendors 112 to specific elements of the user profile information 121 at the discretion of the user. By way of this approach, a specific functional flow for enabling the input and subsequent storage of user profile information 121 is managed by the cross vendor management platform 103 for dictating the means and mode of collecting user information. In certain embodiments, the functional flow may correspond to the execution of one or more data entry procedures for formulating the user information profile 121. Consecutive computations may be linked for execution concurrent with the entry of data for enabling the user to establish logical boundaries that affect distribution of the information even within the cloud 111a-111n. In addition to the semantics of the cloud itself, the user functional flow may dictate the means of mode of collection of user profile information 121 within the context of the cloud 111 for affecting provisioning of user profile information relative to a vendor 112. The collection of user profile information 121 is based, at least in part, on communication logging by at least one device having access to the one or more information spaces, sensor logging by at least one device having access to the one or more information spaces, personal data entry by the at least one user, data extraction of the existing user profile information, or a combination thereof. An exemplary functional flow procedure is depicted more fully with respect to FIGS. 4A-4D.

In certain embodiments, the user may retrieve loyalty program information 123 via the cross vendor management platform 103 and then interact with the vendor 112 by executing one or more computations for processing of the loyalty program information. The one or more computations may include a processing of the loyalty program information 123 for determining a relative exchange rate for loyalty points, offers, or incentives accumulated by the user among the one or more vendors 112a-112n. By way of example, exchange rates may indicate the comparative value the user can expect to receive when redeeming their loyalty points based on one or more offers and incentives for one vendor versus that of another. The exchange rates may also pertain to a relative incentive and arbitrage structure, as shared among multiple vendors, for enabling the seamless exchange and/or transfer of loyalty points based at least in part on available loyalty program information, user profile information, or a combination thereof. It is noted that the exchange rates may be calculated and executed on the basis of one or more exchange policies.

Loyalty points may be accumulated based on the performance of one or more activities by a user respective to their loyalty program information. These activities may include, for example, a number of times a product was purchased, a number of advertisement views, a number of questionnaire or inquiry responses, a number of focus group participations, a number of times one or more incentive, offers or loyalty points was used, or a combination thereof. In certain embodiments, loyalty points are accumulated and tracked by the cross vendor management platform 103 in association with a single organization, service provider, or host thereof.

In certain embodiments, the platform 103 causes presentment of the one or more exchange rates associated with the loyalty program information. More specifically, the determined value of the accumulated loyalty points, one or more offers, one or more incentives, or a combination thereof relative to the exchange agreement among vendors 112a-112n is displayed via UIs 109a-109i. As such, the user may review their exchange rate options, determine which particular vendor 112 best meets their needs, review relative terms and conditions of exchange among vendors 112a-112n, access additional details and comparative data regarding same or similar product offerings, and other like tasks. As this is done by way of the device, the user may also invoke various action buttons for engaging one or more vendors with respect to the one or more offers, incentives and accumulated loyalty points.

In one embodiment, the cross vendor management platform 103 also processes and/or facilitates a processing of one or more computations based on the input to cause, at least in part, a (1) redemption of the one or more loyalty points, the one or more offers, the one or more incentives, or a combination thereof, a (2) comparison of the one or more offers, the one or more incentives, the one or more vendors, or a combination thereof, a (3) purchase of one or more products, or a combination thereof.

By way of example, the UEs 107a-107i, and the cross vendor management platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

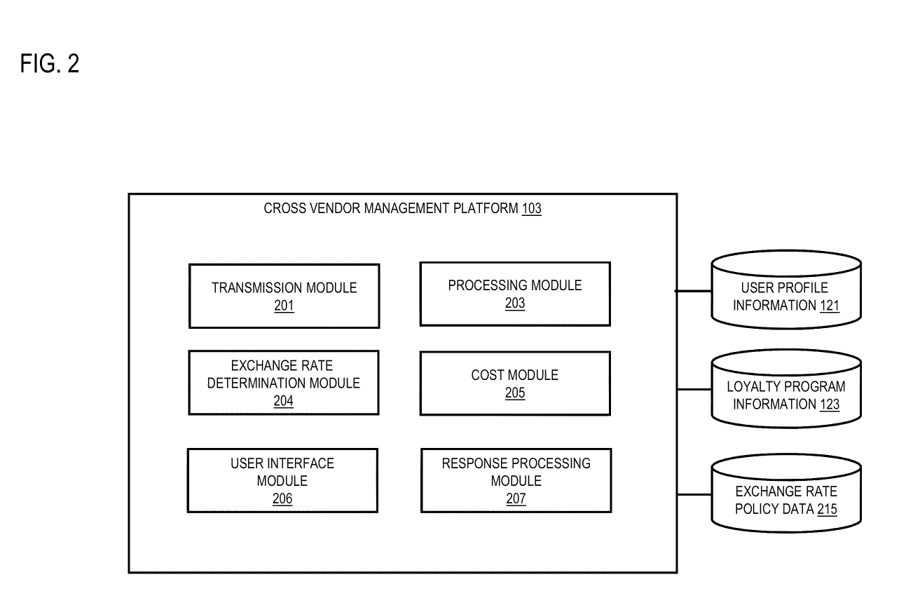

FIG. 2 is a diagram of the components of cross vendor management platform, according to one embodiment. By way of example, the cross vendor management platform 103 includes one or more components for enabling users to control the sharing of user profile information with respect to vendors based on user participation in, or value derived from, one or more vendor loyalty programs. It is contemplated that the functions of these components may be combined in one or more components or performed by other components of equivalent functionality. In this embodiment, the cross vendor management platform includes a retrieval module 201, a processing module 203, an exchange rate determination module 204, a cost module 205, a user interface module 206 and a response processing module 207. In addition, the platform 103 also accesses one or more databases including database 121 for storing profile information, database 123 for storing loyalty program information and database 215 for maintaining exchange rate policy information for enabling the calculation of one or more exchange rates between respective vendors.

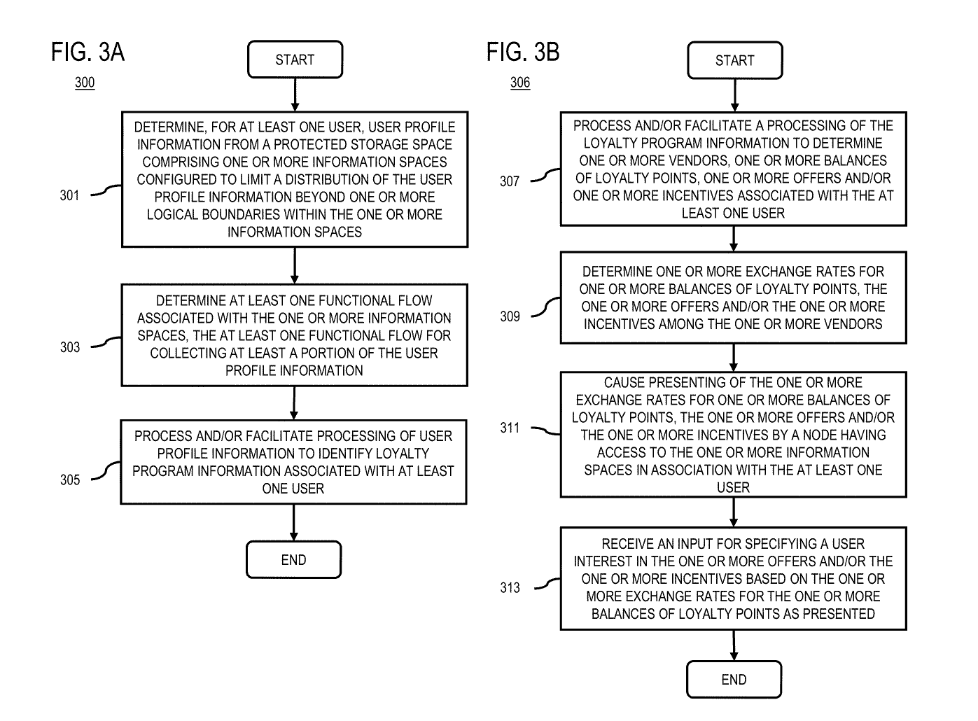

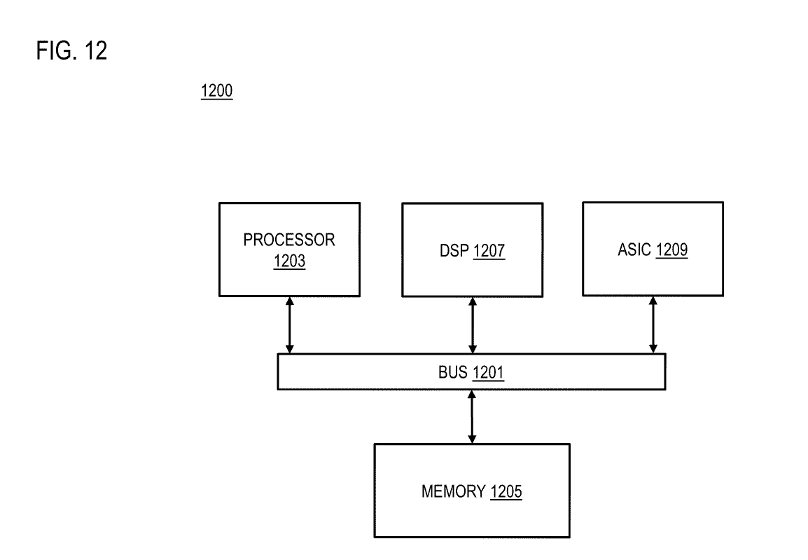

FIG. 2 is described with reference to FIGS. 3A and 3B, which are flowcharts of processes for enabling users to control the sharing of user profile information with respect to vendors based on user participation in, or value derived from, one or more vendor loyalty programs. In one embodiment, the cross vendor management platform 103 performs processes 300 and 306 and is implemented in, for instance, a chip set including a processor and a memory as shown in FIG. 12.

In one embodiment, per step 301 of FIG. 3A, the retrieval module 201 determines, for at least one user, to retrieve user profile information 121 pertaining to a user. By way of example, the retrieval module 201 executes on or more closures for retrieving the information from the information space. As noted, the user profile information 121 is maintained in a protected storage space comprising one or more information spaces or clouds. The information spaces are configured to limit a distribution of at least part of the user profile information, change a rule of a distribution of the user profile information, or a combination thereof 121 beyond one or more logical boundaries within the one or more information spaces.

Per step 303, the retrieval module 201 also determines at least one functional flow associated with the one or more information spaces. The functional flow may include one or more successive computation closures for enabling the collecting/retrieval of user profile information. For example, the retrieval module 201 may be configured by the user to package or filter the user profile information 121 based on various retrieval criteria. Criteria may include a specified date or time interval, geospatial extent, a functional flow that generated the data, a specific attribute of the data (e.g., user identifier), speed or direction data, etc. It is noted that the retrieval module 201 is therefore suited for retrieving data as stored to one or more information stores, as sensed during runtime execution of a user device, or as received or extracted by way of direct user input, etc.

In one embodiment, as shown in step 305 of FIG. 3, the processing module 203 processes and/or facilitates a processing of user profile information in order to identify loyalty program information associated with at least one user. Once the profile information 121 is processed, subsequent processing of associated loyalty program information 123 is also performed per step 307 of process 306 (FIG. 3B). Specifically, in this step the processing module 203 processes loyalty program information to determine one or more vendors, one or more balances of loyalty points, one or more users and/or one or more incentives associated with the at least one user.

An exchange rate determination module 204 is configured by the cross vendor management platform 103 determine one or more exchange rates for one or more balances of loyalty points, per step 309 of FIG. 3B. Exchange rate calculation is also dependent on the one or more offers and incentives associated with a given user based on the retrieved loyalty program information 123. It is noted that the exchange rate determination module 204 is configured to compute comparative exchange rates based on one or more predetermined exchange rate policies 215. By way of example, the exchange rate policy data 215 may indicate one or more ratios, factors or other measures for quantifying a relative price or discount differential between two or more similar incentives. Per step 311, the exchange rate determination module 204 may also operates in connection with a user interface module 206 for causing presentment of the exchange rate data as calculated to one or more UE of the user. In one embodiment, the user interface module 206 is configured to enable execution of one or more application programming interfaces (APIs) and other procedures at the respective devices. The module therefore generates various control signals for affecting run-time execution of the one or more user devices.

In one embodiment, a cost module 205 may also operate in connection with the exchange rate module 204 to determine one or more cost functions associated with the one or more computation closures, the functional flow, one or more nodes (e.g. components) of the information space, or a combination thereof. The one or more cost functions may relate, at least in part, to one or more security costs, one or more energy costs, one or more privacy capability parameters, or a combination thereof. The cost functions for energy and operational range may determine to what extent incentives or offers to which the exchange rates correspond can be performed and by which device. For example, added security cost functions and privacy cost functions can be taken into consideration for affecting whether the vendor or the user device processes a received user input responsive to the generation of exchange rates. The cost of computations on a certain component is based on energy consumption, energy cost, privacy and/or security enforcement measures, processing power/speed, etc., for ensuring optimal execution of the cloud.

In one embodiment, the response processing module 207 receives an input for specifying a user interest in the one or more offers and/or the one or more incentives based on the one or more exchange rates for the one or more balances of loyalty points as presented. This corresponds to step 313 of process 306. By way of example, when the user interface is caused to present one or more offers to a display of a user device, the user may select a particular offer to take advantage of. The selection option is then processed by the module 207 and may include the execution of one or more computations. The response processing module 207 processes and/or facilitates a processing of one or more computations based on the input to cause, at least in part, a (1) redemption of the one or more loyalty points, the one or more offers, the one or more incentives, or a combination thereof, a (2) comparison of the one or more offers, the one or more incentives, the one or more vendors, or a combination thereof, a (3) purchase of one or more products, or a combination thereof.

FIGS. 4A-4D are diagrams of user interfaces representing various functional flows for enabling the control and sharing of user profile information, according to various embodiments. By way of example, the functional flows correspond to the execution of one or more interface screens for enabling interaction between the user and the cross vendor management platform. Particularly, the functional flows pertain to the various means by which a user is able to control the retrieval and/or collection of user profile information within the information space. This includes the means for enabling the user to manage relationships with organizations, select which data to share and which data to conceal, control how data is used by others (e.g., vendors) and for how long, and other functions. In certain embodiments, it is contemplated that the various interfaces may support the establishment or generation of a user profile information record and/or a personal profile stronghold for use over an information space.

FIG. 4A presents an interface for enabling the configuration of personal data by way of manual entry, i.e., as a web-based form. The interface 400 features a firmographic information data entry section 403, which includes various fields for capturing information pertaining to the user's occupational or employer status. For example, the user may select one or more drop down menus to indicate a specific role, industry, location size, organization size, number of locations and headquarters country and state information. Also, an education history data entry section 405 includes various fields for capturing information pertaining to the user's educational background. For example, the user may enter the names of the various schools attended from the Primary to Graduate level. Various other fields are also presented for receiving data regarding the year of graduation as well as the GPA of the user at the various stages of their education.

It is noted that the information can be updated (e.g., added or deleted) at the discretion of the user. In addition, one or more action buttons are featured for supporting user interaction, including a “PREV” action button 407 for reverting back to a prior instance of input at various of the fields, an “UPDATE” action button 409 for accepting any data input to the various fields and a “CANCEL” action button 411 for cancelling any data entry operations.

FIG. 4B presents an interface for enabling the configuration and management of group related data related to the user. The interface 414 features a user defined group list section 416. Selection of a particular group also enables selection of an associated contact list 415 for displaying the various contacts associated with the group. By way of example, when the user selects the defined group entry “Judo” 417 from the list 416, the user's martial arts class members are presented in the contacts section 415. The user can also add or delete entries to the lists 417 and 415, such as by selecting a “CREATE” link 419 or selecting a “DELETE” icon 420 respectively.

An “IMPORT CONTACTS” link 421 is also available for selection for enabling the user to import contacts from other sources via the information space. For example, contacts from an e-mail application, customer relationship management tool, online contact database or a social networking site may be imported and organized into one or more groups. Groups and contacts can also be merged and/or synchronized across applications. It is noted that the functional flow supports. The functional flow may also support drag and drop execution of contacts into one or more groups, i.e., by way of touch screen input. As mentioned previously, this input as received from the user may be the basis of one or more computations for affecting additional executions of the cross vendor management platform 103.

FIG. 4C presents an interface for enabling the configuration and management of shared resources. The interface 424 features a user defined group list 416, along with a resources list 425 for indicating one or more resources associated with a select group entry. By way of example, when the user selects the user defined “Family” group entry 423, all resources associated for that group are listed in section 425. In the example, the resources include various categories for representing the storage of records, documents and photos. While not shown, user selection of a given resource entry results in a listing of the various records, documents and photos. Additional file types may also be maintained as resources, including audio, video and one or more executable applications—i.e., a tax preparation application.

A user may select a “PRIVATE” link 431 to filter the resource list 425 for display of only private resources. In addition, an “ALL” link 433 may be selected for displaying all groups within the group list 416. While not shown, selection of a particular group entry results in a listing of additional information regarding the group. This may include for example, a contact number, e-mail address, primary point of contact, etc. It is noted that drag and drop execution may be supported. Also, the user/consumer is able to customize data packages (for retrieval and/or collection of profile information) on the basis of time, geo-spatial extent, functional flow, specific attribute, etc.

FIG. 4D presents an interface for enabling the configuration of personal data control and updating. Reference is made again to interface 400 of FIG. 4A, which is shown by way of example in miniaturized form in FIG. 4D. The configuration interface 400 features one or more data sharing control buttons 406a and 406b, which are associated with the firmographic information section 403 and education history section 405 respectively. When the user selects a data sharing control button, a data view 435 for enabling user selection of one or more groups and/or contacts to be associated with specific elements of data is caused to be presented as part of the functional flow. By way of example, the data view 435 presents a matrix, featuring numerous columns and rows that represent various data elements (inputs) of the various configuration screens. Under the present scenario, the columns correspond to one or more user defined groups maintained in the group list 16 of FIG. 4B, i.e., Judo, Work, etc. The rows that span across particular column corresponding to a particular attribute name or data entry field of the firmographic section 403. This includes a row for the role, industry, location size, etc.

A user may select or deselect a matrix entry in order to enable or disable the sharing of the corresponding attribute in the matrix with a particular group. For example, for the column 437 representing the Judo group designation, only the role attribute is selected for inclusion and sharing with contacts that fall into this group. For the column 439 representing the Work group designation, however, all of the attributes of the firmographic section 403 are selected for inclusion and sharing with the contacts that fall into this group. This feature may be executed at any point in the functional flow for affecting the sharing or unsharing of specific information within the information space. It is noted also that this feature allows users to easily update their data setting features within context of the specific category of information to be impacted by the selection (or lack thereof).

As mentioned previously, the above described functional flows and corresponding response input provided by a user during execution of said flows dictates the means of data collection and/or level of access to data by respective interacting nodes within the information space. From the standpoint of a vendor related interaction, the user is able to indicate and control how they want to share their user profile information while still engaging with the vendor for specific reasons—i.e., to explore products, make purchases, etc.

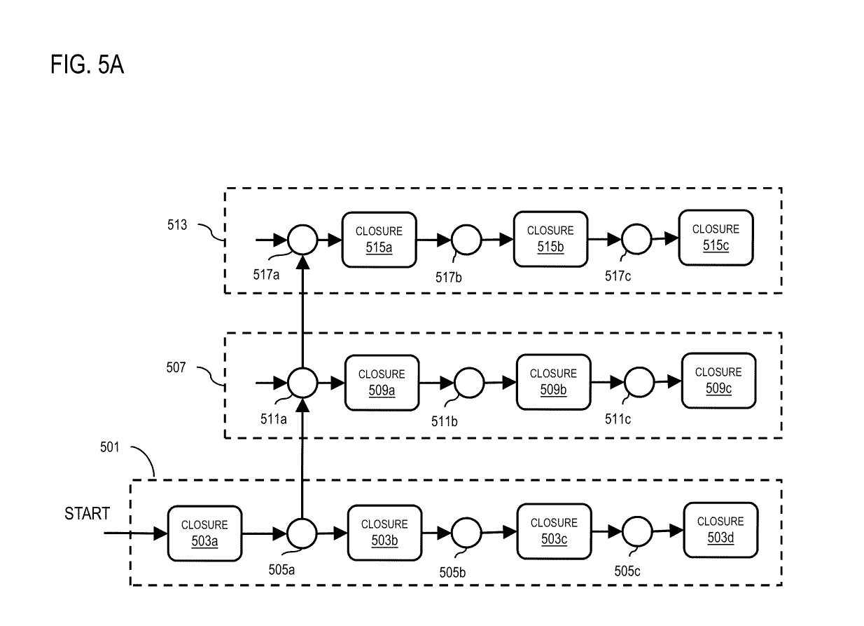

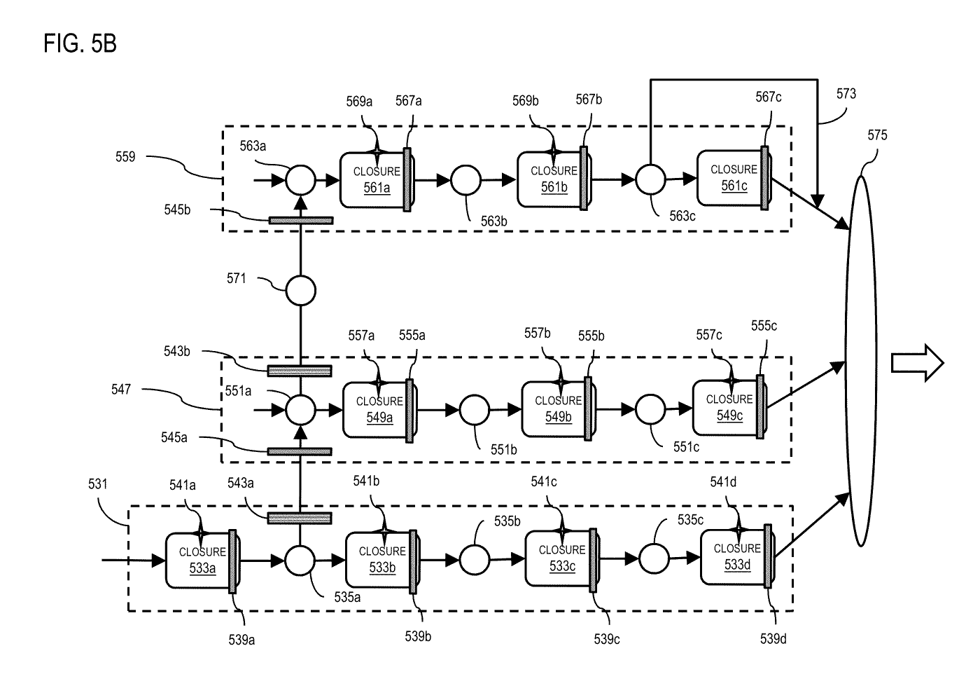

FIGS. 5A and 5B are diagrams of distribution of controlled user profile information and energy optimization in multi-level computational architecture, according to various embodiments. As seen in FIG. 5A, the computation distribution starts at a component 501. Each component may execute a set of closures that constitute a computation branch. For example, the branch 501 is composed of closures 503a-503d, wherein every two consecutive closures are connected via a connector and computational branches are communicating via connectors as well. For example, connectors 505a-505c connect closures 503a-503d. Connectors may also transfer information and data associated with a closure and its execution results to the next closure in the branch or to other branches. Additionally, connectors may function as links between related branches that constitute a distributed computation.

In one embodiment, connectors may contain information about parameters such as security requirement and/or capabilities, functional flows, distribution maps, links between closures and architectural levels, etc. Arrows connecting closures to connectors and connectors to next closures show the functional flow adopted based on the parameters. As seen in FIG. 5A, the closures have been distributed from component 501 to component 507 via communication between connector 505a and connector 511a. The computation branch of component 507 includes closures 509a-509c communicating via connectors 511b and 511c, while branches 501 and 507 communicate via connectors 505a and 511a. Similarly, a third branch 513 has been formed of closures 515a-515c being executed at component 513 and connected by connectors 517b and 517c, while the branch communicates with other branches via connector 517a.

In one embodiment, the initial branch 501 may be in a UE 107a-107i, the second branch 507 in a component of the infrastructure 117a-117n, and the third branch in another component of the same infrastructure, a different infrastructure, in a cloud, or a combination thereof.

FIG. 5B shows a computation distribution together with various parameters affecting the distribution. As seen in FIG. 5B, the computation distribution starts at a component 531 of an architectural level (not shown). Each component may execute a set of closures that constitute a computation branch. For example, the branch 531 is composed of closures 533a-533d, wherein every two consecutive closures are connected via a connector and computational branches are communicating via connectors as well. For example, connectors 535a-535c connect closures 533a-533d and connector 571 connects branches 547 and 559. Likewise, connectors 551a-551c connect closures 549a-549c, while connectors 563a-563c connect closures 561a-561c. Connectors may also transfer information and data associated with a closure and its execution results to the next closure in the branch or to other branches. Additionally, connectors may function as links between related branches that constitute a distributed computation.

In one embodiment, connectors may contain information about parameters such as capabilities including security requirements and availability, a cost function, functional flow specifications, distribution maps, links between closures and architectural levels, etc. Arrows connecting closures to connectors and connectors to next closures show the functional flow adopted based on the parameters. For example, star signs 541a-541d, 557a-557c, and 569a-569b, represent security rules imposed on the closures and the signs 545a-545b represent the security rules imposed on superclosures by the user of UEs 107a-107i, default by the manufacturer of UEs 107a-107i, by the infrastructures 117a-117k, by the clouds 111a-111n, or a combination thereof, and associated with each closure 533a-533d, 549a-549c, and 561a-561c respectively. Additionally, blocks 539a-539d, 555a-555c, and 567a-567c represent signatures for one or more closures, and blocks 543a-543b represent supersignatures for one or more superclosures. In the example of FIG. 5B, the signature 539a shows the signature for closure 533a based on the rules 541a. In one embodiment, if signature 539a is in accordance with rules 541, the signature is validated and the closure 533a can be distributed, however if signature 539a contradicts any rule of rules 541a, the closure 533a will be identified as invalid by the authentication module 207.

In one embodiment, the block 543a represents a supersignature composed of a set of signatures 539a-539d and block 545a represents combined security rules of component 547 of the multi-level computation architecture. In this embodiment, if the authentication module 207 detects a contradiction between the supersignature 543a and the rules 545a, the super signature 543a is decomposed into its root elements (e.g. 539a-539d) and the authentication module 207 verifies the root signatures against rules 545a. The verification may lead to finding one or more invalid root elements (e.g. closures 539a-539d).

In one embodiment, a closure or a group of closures may lack access to security rules for the verification of their signatures. For example, in FIG. 5B the closure 561c is signed with signature 567c with no rules. In this embodiment as seen by arrow 573, the authentication module 207 may tag the closure 561c as invalid so that the distributed computation component that is executing branch 559 bypass the closure 561c without executing the computation 561c. The final results from closure execution of the three branches 531, 547, and 559 are aggregated by result aggregator 575 and forwarded to the requesting device.

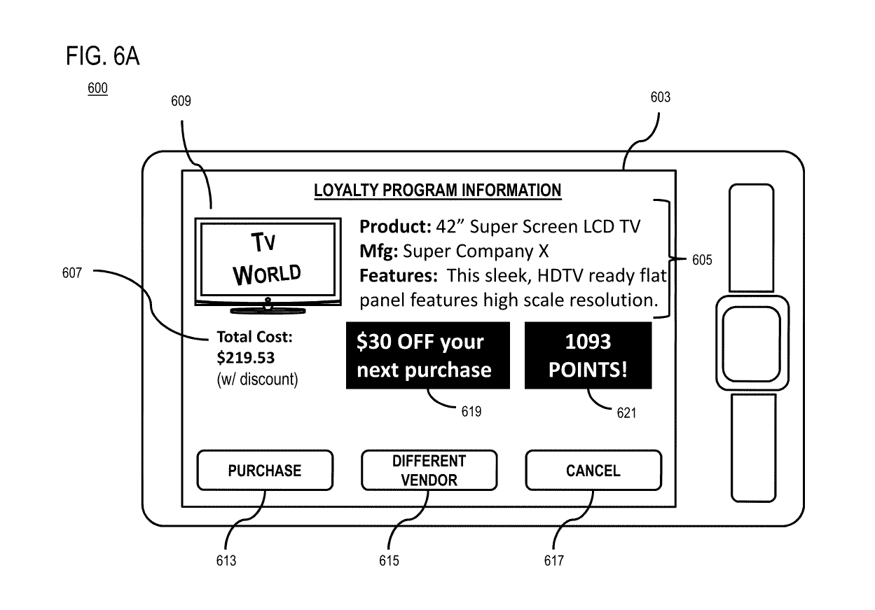

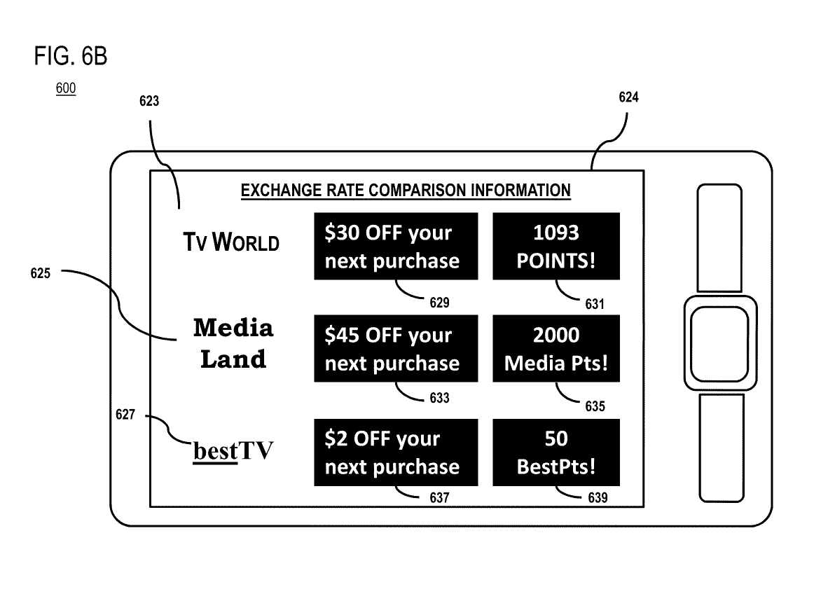

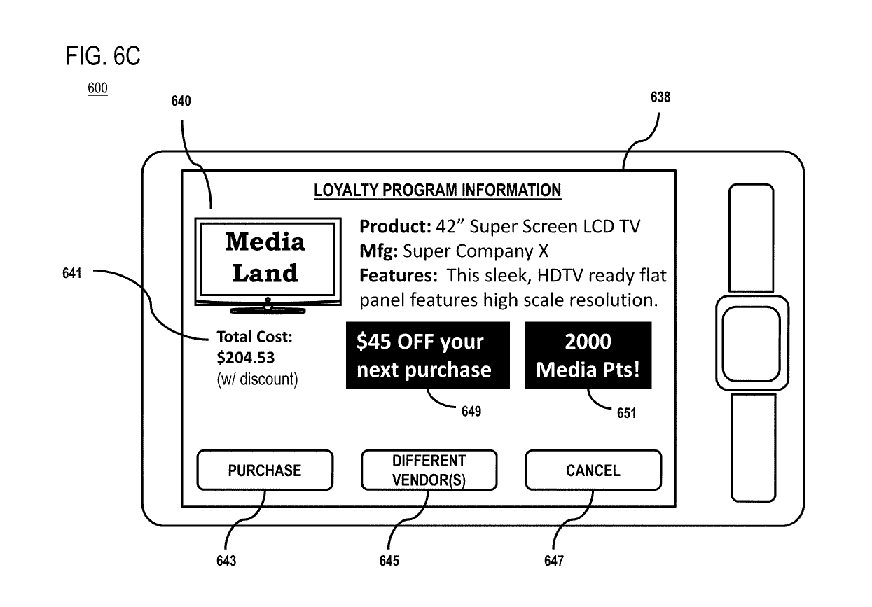

FIGS. 6A-6C are diagrams of user interfaces utilized in the processes of FIGS. 3A and 3B, according to various embodiments. For example purposes, the figures are described from the perspective of a use case scenario of a user interacting with a vendor via an information space to review various loyalty program incentives, offers and points as accumulated. The executions as described are performed with respect to the cross vendor management platform 101 of FIG. 1.

In FIG. 6A, the user accesses data regarding their loyalty program involvement with a specific vendor TV World, such as by way of a loyalty program information interface 603. The display of the device 600 includes various data elements, including an icon 609 for indicating the specific vendor the loyalty information corresponds to, a product description section 605 for displaying details of the offer and/or product, a total cost notification 607 for indicating the post discounted cost to the user for taking advantage of a particular offer, a value indicator 619 for monetizing the offer and a loyalty points indicator 621 for representing the balance of points accumulated.

The user may select from various action buttons for interacting with the functional flow, and thus impacting operation of the cross vendor management platform 103. A “PURCHASE” action button 613 enables the user to initiate a purchase transaction with the vendor for purchasing the item from TV World. A “CANCEL” action button 617 enables the user to exit from the loyalty program information interface 603. When the user selects a “DIFFERENT VENDOR” action button 615, an exchange rate comparison interface 624 is caused to be presented to device 600 as shown in FIG. 6B.

The exchange rate comparison interface 624 presents all of the various vendors 623-627 and their respective offers available to the user based on the product of interest, i.e., the television as described in section 605 in FIG. 6A. For a first vendor TV World 623, the user is being offered a $30 discount 629 to be applied toward the purchase of the television, which corresponds to 1093 points 631. For a second vendor Media Land, the user is being offered a $45 discount 633 corresponding to 2000 Media Points 635, which is the name given to points via that vendors loyalty program. A third vendor bestTV 627 offers a $2 discount 637 corresponding to only 50 Best Points 639. The user may quickly scan the various options and determine that the Media Land incentive is best by way of comparison. In response to this determination, the user selects the Media Land logo to activate another interface screen 638 for showing the details of the selected offer, as presented in FIG. 6C.

Having selected the particular offer of interest, the details presented to the interface 638 of the device include the logo for the vendor 640, a total cost indicator respective to the newly selected vendor/offer 641, the monetary value indicator 649 for the offer, associated loyalty points balance 651. In addition, one or more action buttons 643-647 enable the user to facilitate a purchase, select a different vendor or cancel the interaction altogether.

It is noted that vendors, retailers and the like often have loyalty plans designed to bring consumers back to the their retail stores by giving them incentives in the form of (1) cash back, (2) points that can be used for discounts, or (3) coupons. The above described system 100 of FIG. 1 provides a personalized, secure platform for enabling selective engagement with vendors that performs the following:
1. Enables the user/consumer to keep track of all value earned in terms of points;
2. Analyzes the consumer's profile information for enabling processing and generation of one or more computations within the information space;
3. Based on the user profile information and loyalty program information, the system identifies and pulls the vendor's best deals that are relevant for their consumer;
4. Enables the consumer to visually review the points, incentives and offers gathered,
5. Enables the consumer to exchange vendor specific points by way of an exchange mechanism for other vendor points; comparative value calculations are performed for arbitration and reconciliation purposes.

In effect, the user is able to redeem and use loyalty points across vendors within the within the cloud. Of note, the loyalty points accumulated by a respective user may pertain to one or more of the respective vendors, a provider of the cross vendor management platform 103 (e.g., a wireless communication company), or a combination thereof.

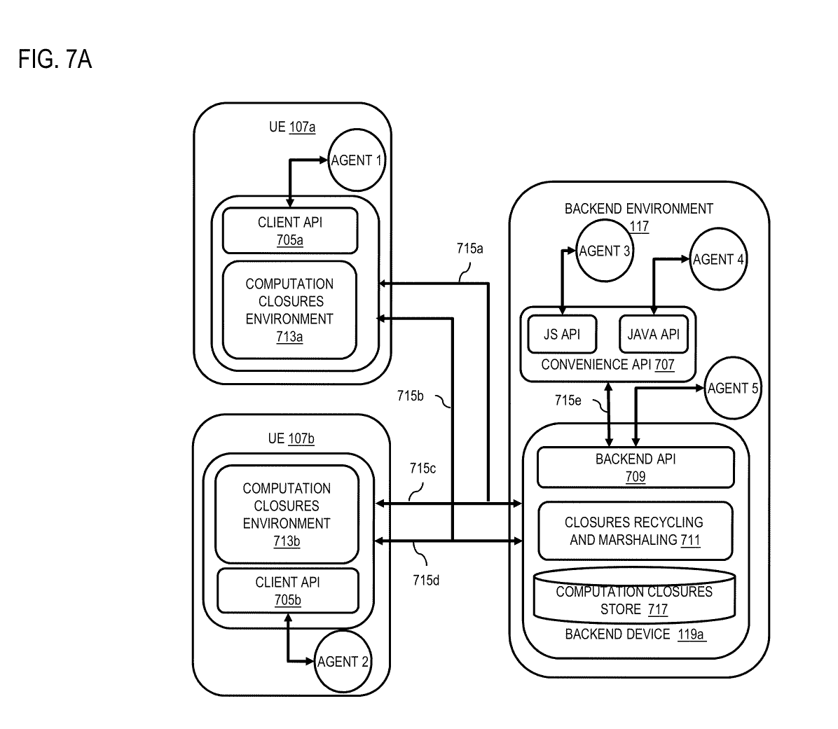

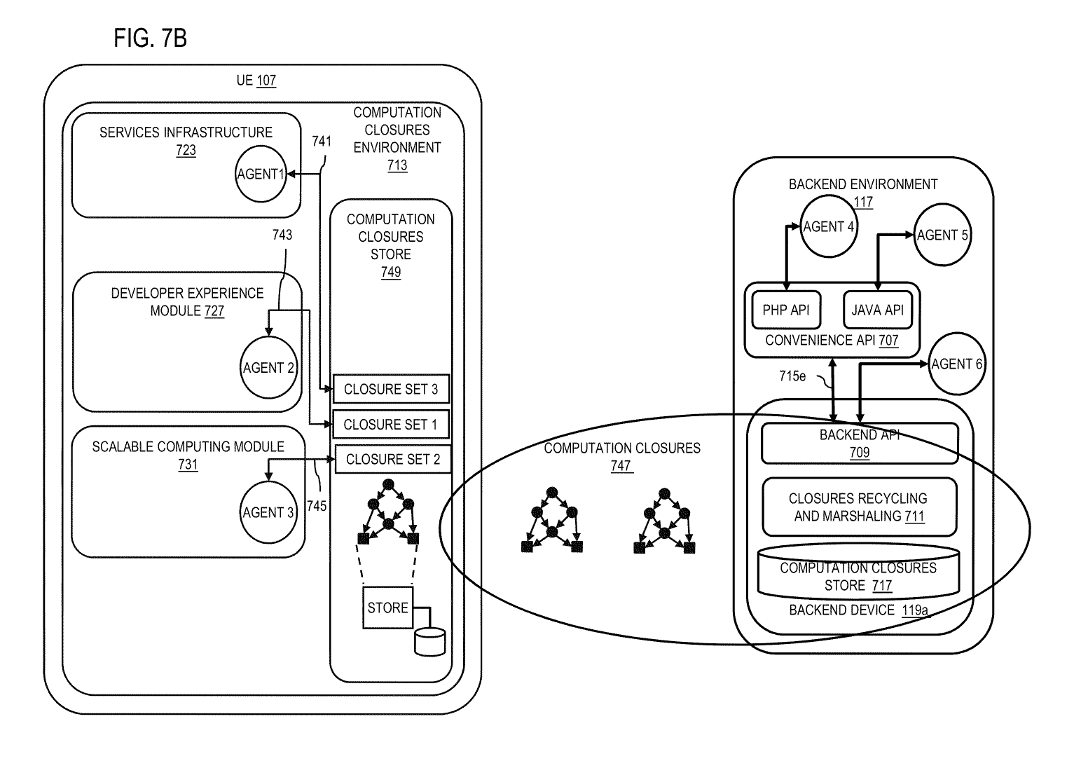

FIGS. 7A-7B are diagrams of computation distribution among devices, according to various embodiments. In one embodiment, in FIG. 7A, the backend environment 117 is a network infrastructure. The backend environment may also be a virtual run-time environment within a cloud 111 associated with the owner of UE 107a or on another UE 107b associated with the user. The backend environment 117 may include one or more components (backend devices) 119a and one or more Application Programming Interface (API) such as a convenience API 707 that may include APIs tailored to the software development environments used (e.g. JAVA, PHP, etc.). Furthermore, UEs 107a and 107b may include client APIs 705a and 705b. Each API enables interaction between devices and components within another device or an environment. For example, backend API 709 enables interaction between the backend device 119a and Agent5, and convenience API 707 enables interaction between the backend device 119a and agents Agent3 and Agent4, wherein each agent is a set of processes that handle computation closures within the backend environment 117. APIs 705a and 705b enable interaction between UE 107a and agent Agent1, and UE 107b and agent Agent2 respectively. As seen in the example of FIG. 7A, Agent3 works under PHP while Agent4 is a JAVA process. Each of the UEs 107a and 107b has a computation closure environment 713a and 713b which may be part of a cloud 111. Arrows 715a-715e represent distribution path of computation closures among the environments 713a, 713b and the computation closures store 717. The computation closures store 717 is a repository of computation closures that can be accessed and used by all the UEs and infrastructure components having connectivity to the backend environment 117.

In one embodiment, the backend device 119a may be equipped with a closure recycling and marshaling component 711 that monitors and manages any access to the computation closures store 717. In other embodiments the closure recycling and marshaling (i.e. standardization for uniform use) may be a function of the cross vendor management platform 103.

In one embodiment, the computation closures within environments 713a, 713b and the computation closures store 717 may be composed based on anonymous function objects and automatically created by a compiling system using methods for generating anonymous function objects such as lambda expressions.

FIG. 7B is an expanded view of a computation closure environment 713 as introduced in FIG. 7A. The computation closure environment 713 may be composed of one or more computation closure generating components. In one embodiment the computation closure environment 713 has a services infrastructure 723 that provides various services for the user of the UE 107. The services may include any application that can be performed on the UE 107 such as, games, music, text messaging, voice calls, etc. In one embodiment, the services infrastructure 723 provides support for closure distribution under the supervision of a cross vendor management platform 103 as discussed in FIG. 1, FIG. 2, and FIG. 3. The agent Agent1 retrieves the computation closures required by the services infrastructure 723 from the computation closures store 749 and stores the newly generated computation closures by the services infrastructure 723 into the computation closures store 749 for distribution purposes per arrow 741.

In another embodiment, the computation closure environment 713 has a developer experience module 727 that provides various tools for a developer for manipulating services offered by the UE 107. The tools may include standardized and/or abstract data types and services allowing the developers to chain processes together across development platforms. In one embodiment, the developer experience module 727 provides cross platform support for abstract data types and services under the supervision of a cross vendor management platform 103 as discussed in FIG. 1. The agent Agent2 retrieves the computation closures required by the developer experience module 727 from the computation closures store 749 and stores the newly generated computation closures by the developer experience module 727 into the computation closures store 749 for distribution purposes per arrow 743.

In yet another embodiment, the computation closure environment 713 has a scalable computing module 731 that provides an abstract wrapper (i.e. monadic wrapper) for the transmitting closures 401. This abstraction provides computation compatibility between the closures 401 and the UE 107. The abstract wrapper may provide scheduling, memory management, system calls and other services for various processes associated with the closures 401. These services are provided under the supervision of the cross vendor management platform 103 as discussed in FIG. 1. The agent Agent3 retrieves the computation closures required by the scalable computing module 731 from the computation closures store 749 and stores the newly generated computation closures by the scalable computing module 731 into the computation closures store 749 for distribution purposes per arrow 745. In one embodiment, the backend environment 117 may access the computation closures store 749 and exchange/transmit one or more computer closures 747 between the computation closures store 749 and the backend computation closures store 717.

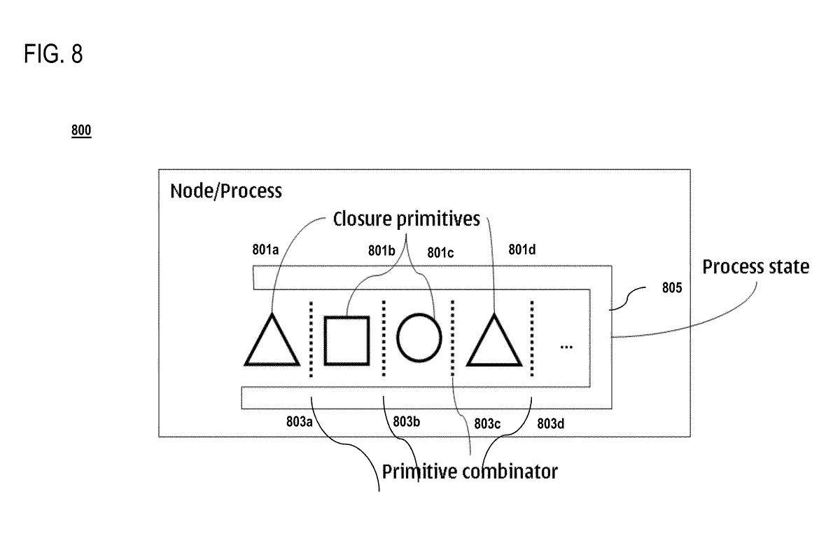

FIG. 8 is a diagram showing a process as a combination of primitive computation closures, according to one embodiment. Process 800 consists of closure primitives 801a-801d. The closure primitives 801a-801d, which are similar to geometric icon closures of FIG. 4, are combined with each other into process 800 by combinators 803a-803d. The object 805 represents the execution requirements including process states under which the execution of closures 801a-801d combined by combinators 803a-803d will result in the process 800.

In one embodiment, distribution of process 800 includes distribution of closures 801a-801d, combinators 803a-803d and the process states 805 as independent elements into, for instance, an infrastructure environment 117. The independent closures 801a-801d from infrastructure environment 117 may be distributed into different components 119a-119m where they may be executed.

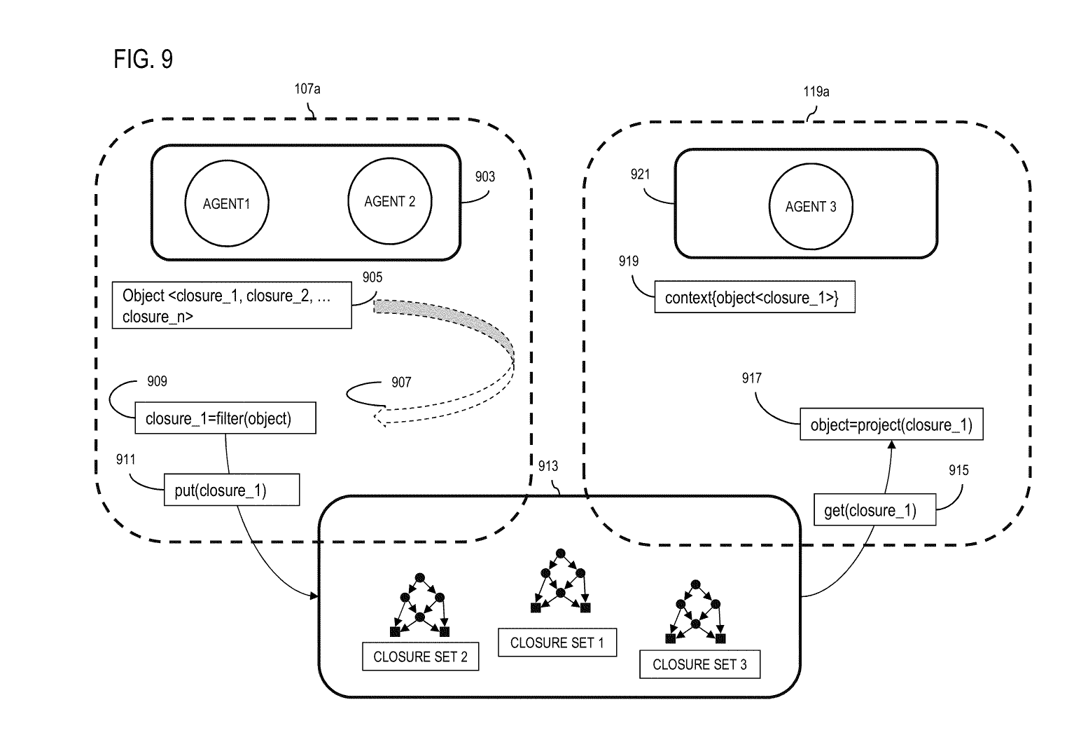

FIG. 9 is a diagram of process distribution from a device to another device, according to one embodiment. In one embodiment, the device 107a is a UE associated with the user. The UE 107a may include a user context 903 which is being transmitted among devices. Agent1 and agent2 are processors that calculate and handle computation closures within the user context 903. The number of agents may be different in different devices based on their design, functionality, processing power, etc. Block 905 represents an Object as a set of computation closures, closure_1, closure_2, . . . , and closure_n, where each closure is a component of a larger process, for example, related to a service provided to the user by the user equipment 107a. Each closure is a standalone process that can be executed independently from the other closures. In the example of FIG. 9, the filtering process 907 extracts closure_1 from the closure set Object via filtering the set (shown in block 909). The extracted closure_1 is added to a computation closure store 913 using the exemplary Put command 911.

It is assumed, in this example, that component 119a of an infrastructure level (not shown) is selected by the cross vendor management platform 103 as a destination for closure distribution from UE 107a, based on the availability of sufficient security. The extracted computation closure, closure_1 is transmitted to component 119a following the assignment of a distribution path.

In one embodiment, the component 119a receives the computation closure closure_1 and extracts it from the computation closure store 913 using the Get command 915. The extracted closure_1 is projected into a closure with the user device context and the object 917 is produced. The block 919 represents the reconstruction of the closure into the initial context by a component in charge of the execution. The aggregated context may then be executed in the run-time environment 921 of component 119a by Agent3.

In another embodiment, the UE 107a and component 119a may exchange places and the distribution is performed from the component 119a to UE 107a or both devices may be UEs. In this embodiment the decomposition and aggregation processes are similar to the above example.

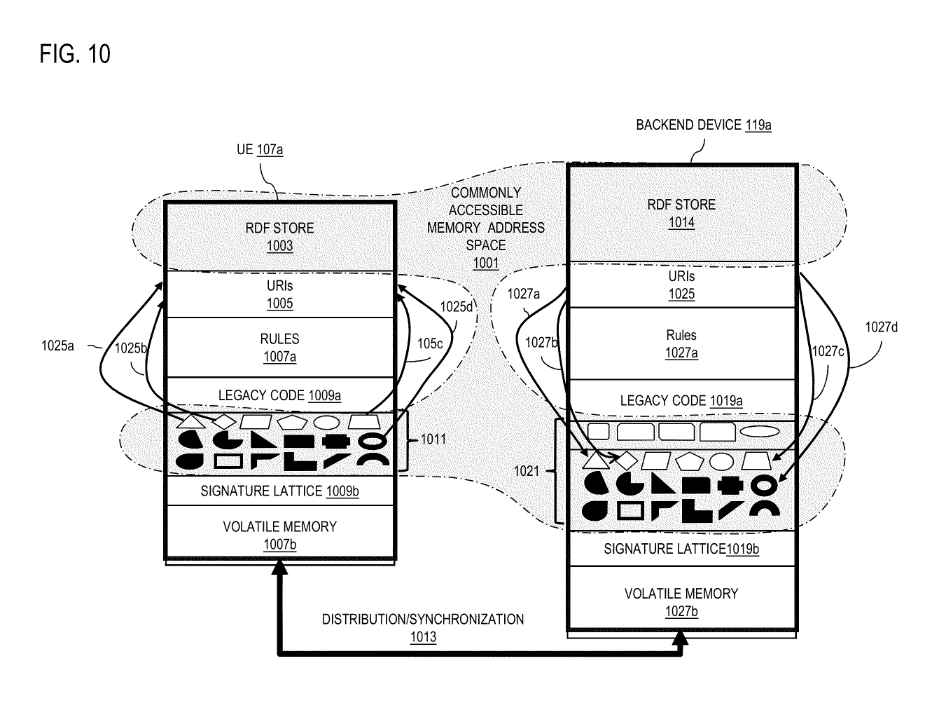

FIG. 10 is a diagram of computation closure allocation/mapping, according to one embodiment. The diagram of FIG. 10 shows a commonly accessible memory address space 1001 formed between a UE 107a as a client and the backend device 119a as a component of a computation infrastructure 117.

In one embodiment, the UE 107a may include RDF store 1003, which holds computation closures for processes associated with the UE 107a. Similarly the backend device 119a may includes a RDF store 1014, which holds computation closures associated with processes related to device 119a, UEs 107a-107i, or any other devices having connectivity to device 119a or cloud 111.

In other embodiments, the Uniform Resource Identifiers (URIs) 1005 in UE 107a and 1015 in backend device 119a may be used to identify names or resources accessible to their respective devices via the communication network 105. Additionally, UE 107a and backend device 119a may have rule sets 1007a and 1017a that include security rules imposed on device similar to rules 569a-569b of FIG. 5B. It is noted that the rule base 1007a of UE 107a may be a subset of the rule base 1017a of the backend device 119a, wherein the rules 1017a is a subset of a superset of rules managed by a cloud 111. Furthermore, the legacy codes associated with each device may be stored in legacy code memory areas 1009a and 1009b on UE 107a and 1019a and 1019b on backend device 119a.

In one embodiment, UE 107a may be provided with a non-volatile memory space 1011 as a closure store. The closure store 1011 may include a set of closure primitives shown as geometric objects, similar to primitives of sets 401 or 403 of FIG. 4. Similarly, the backend device 119a may be provided with a non-volatile memory space 1021 as a closure store. The closure store 1021 may also include a set of closure primitives shown as geometric objects. In one embodiment, the closure store 1011 is a subset of closure store 1021 determined, at least in part, based on one or more criteria such as time of access, frequency of access, a priority classification, security settings, etc. The geometric shapes of closure stores 1011 and 1021 have been each divided into two groups of solidly filled geometric shapes (representing signed closures) and unfilled geometric shapes (representing unsigned closures). Since non-volatile memories are costly and require extensive resources (e.g. power consumption) compared with volatile memories (such as 1007a, 1007b, 1017a, and 1017b), the capacity of non-volatile memory on a UE 107a-107i is limited. However, a backend device 119a, serving high numbers of users, may be equipped with larger volumes of non-volatile memory spaces. Because of the limited capacity of non-volatile memory spaces on UEs 107a-107i, and also because differing levels of security setup on various devices, only a subset of the closure store 1021 is stored locally at the closure store 1011 for local use by the UE 107a. In order to minimize the number of times a UE 107 needs to retrieve one or more primitives from closure store 1021 of device 109a, the subset 1011 is determined based on one or more criteria. In one embodiment, the closure store 1011 may be determined as a set of the most frequently accessed closure primitives of closure store 1021 by UE 107a. In another embodiment, the closure store 1011 may be determined as a set of the most recently accessed closure primitives of closure store 1021 by UE 107a. In other embodiments, various combined conditions and criteria may be used for determining subset 1011 from set 1021 as the content of closure store for UE 107a. Furthermore, the closure stores 1011 and 1021 may be periodically synchronized. The synchronization of closure stores ensures that any changes (addition, deletion, modification, etc.) in closure primitives and in root elements of the signature lattice of closure store 1021 are reflected in the closure store 1011.

In one embodiment, for execution of a closure set 401 (a subset of closure store 1011) associated with a process on UE 107a, the set 401 can be transmitted under the supervision of the cross vendor management platform 103 and after verification of the security of closures and capabilities of the destination component, to the backend device 119a which is a component of the infrastructure 117 (the distribution path shown as arrow 1023). The cross vendor management platform 103 may then inform the processing components of the UE 107a, the backend device 119a or a combination thereof (the processing components are not shown), that the security of closure primitives has been approved and the closures are ready for execution. Alternatively, the cross vendor management platform 103 may determine that the closures are not approved from point of view of the security and terminate their distribution and execution.

In one embodiment, any changes on the closure store 1021 of the backend device 119a (e.g., addition, deletion, modification, etc.) may first enter the URIs 1015 via the communication network 105. The changes may then be applied from URIs 1015 on closure store 1021 shown by arrows 1027a-1027d. Similarly, the closure store 1011 is updated based on the content of the closure store 1021 and the updates are shared with other authorized components within UE 107a (e.g. with URIs 1005 as shown by arrows 1025a-1025d).

The processes described herein for enabling users to control the sharing of user profile information with respect to vendors based on user participation in, or value derived from, one or more vendor loyalty programs may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

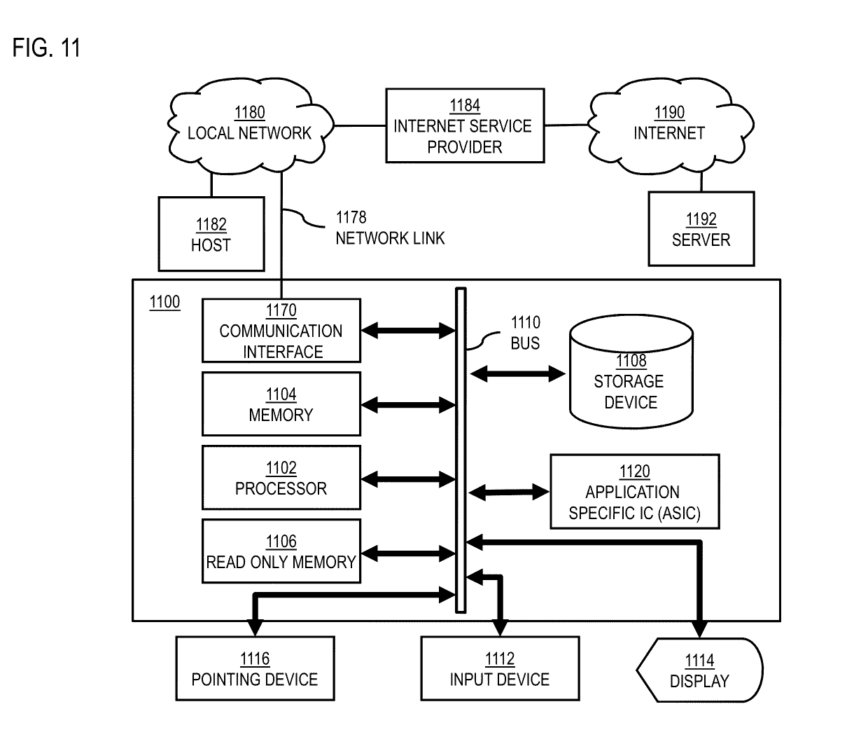

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to provide secure signing and utilization of distributed computations as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of providing secure signing and utilization of distributed computations.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to providing secure signing and utilization of distributed computations. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or any other dynamic storage device, stores information including processor instructions for providing secure signing and utilization of distributed computations. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing secure signing and utilization of distributed computations, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for providing secure signing and utilization of distributed computations to the UEs in sets 101a-101n.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to provide secure signing and utilization of distributed computations as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of providing secure signing and utilization of distributed computations.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide secure signing and utilization of distributed computations. The memory 1205 also stores the data associated with or generated by the execution of the inventive steps.

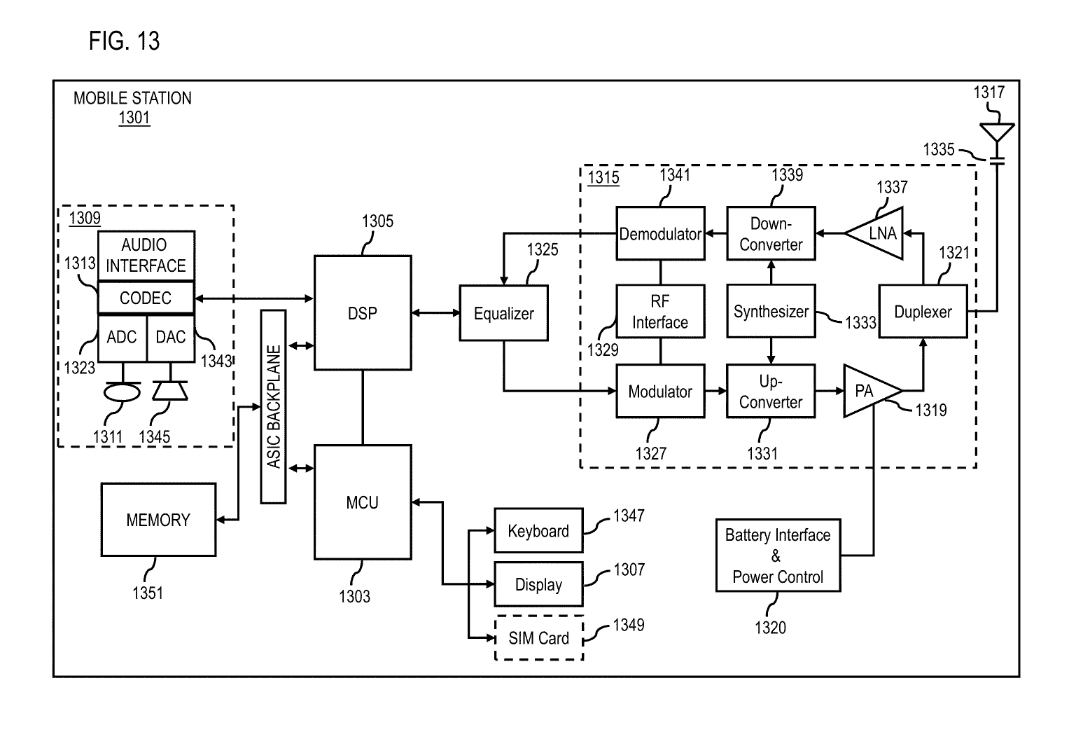

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of providing secure signing and utilization of distributed computations. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of providing secure signing and utilization of distributed computations. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairment that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to provide secure signing and utilization of distributed computations. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a processing of user profile information to identify loyalty program information associated with at least one user,
wherein the user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

2. A method of claim 1, wherein the (1) data and/or (2) information and/or (3) at least one signal are further based, at least in part, on the following:
at least one functional flow associated with the one or more information spaces, the at least one functional flow for collecting at least a portion of the user profile information.

3. A method of claim 2, wherein the at least one functional flow is associated with a means of collection of the user profile information associated with the one or more information spaces, a level of access to the user profile information associated with the one or more information spaces, or a combination thereof.

4. A method of claim 3, wherein the means of collection includes communication logging, sensor logging, data entry of the user profile information, data extraction of the user profile information, or a combination thereof.

5. A method of claim 2, wherein the at least one functional flow comprises one or more computation closures.

6. A method of claim 1, wherein the (1) data and/or (2) information and/or (3) at least one signal are further based, at least in part, on the following:
a processing of the loyalty program information to determine one or more vendors, one or more balances of loyalty points, one or more offers, one or more incentives, or a combination thereof associated with the at least one user; and
at least one determination of one or more exchange rates for one or more balances of loyalty points, the one or more offers, the one or more incentives, or a combination thereof among the one or more vendors.

7. A method of claim 6, wherein the (1) data and/or (2) information and/or (3) at least one signal are further based, at least in part, on the following:
a presentation of the one or more exchange rates for one or more balances of loyalty points, the one or more offers, the one or more incentives, or a combination thereof by at least one node associated with the one or more information spaces in association with the at least one user; and
an input for specifying a user interest in the one or more offers, the one or more incentives, or a combination thereof based, at least in part, on the one or more exchange rates for the one or more balances of loyalty points as presented.

8. A method of claim 7, wherein the (1) data and/or (2) information and/or (3) at least one signal are further based, at least in part, on the following:
a processing of one or more computations based on the input to cause, at least in part, a (1) redemption of the one or more loyalty points, the one or more offers, the one or more incentives, or a combination thereof, a (2) comparison of the one or more offers, the one or more incentives, the one or more vendors, or a combination thereof, a (3) purchase of one or more products, or a combination thereof.

9. A method of claim 8, wherein the processing is caused to be performed by the at least one node.

10. A method of claim 1, wherein the loyalty program information includes data for indicating a quantity of product purchases, advertisement views, inquiry responses, focus group participations, incentives used, offers used, loyalty points used, or a combination thereof, in association with the at least one user.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of user profile information to identify loyalty program information associated with at least one user,
wherein the user profile information is determined from a protected storage space comprising one or more information spaces configured, at least in part, to limit a distribution of at least part of the user profile information, change a rule of a distribution of the user profile information, or a combination thereof beyond one or more logical boundaries within the one or more information spaces.

12. An apparatus of claim 11, wherein the apparatus is further caused to:
determine at least one functional flow associated with the one or more information spaces, the at least one functional flow for collecting at least a portion of the user profile information.

13. An apparatus of claim 12, wherein the at least one functional flow is associated with a means of collection of the user profile information associated with the one or more information spaces, a level of access to the user profile information associated with the one or more information spaces, or a combination thereof.

14. An apparatus of claim 13, wherein the means of collection includes communication logging, sensor logging, data entry of the user profile information, data extraction of the user profile information, or a combination thereof.

15. An apparatus of claim 12, wherein the at least one functional flow comprises one or more computation closures.

16. An apparatus of claim 11, wherein the apparatus is further caused to:
process and/or facilitate a processing of the loyalty program information to determine one or more vendors, one or more balances of loyalty points, one or more offers, one or more incentives, or a combination thereof associated with the at least one user; and
determine one or more exchange rates for one or more balances of loyalty points, the one or more offers, the one or more incentives, or a combination thereof among the one or more vendors.

17. An apparatus of claim 16, wherein the apparatus is further caused to:
cause, at least in part, presenting of the one or more exchange rates for one or more balances of loyalty points, the one or more offers, the one or more incentives, or a combination thereof by at least one node associated with the one or more information spaces in association with the at least one user; and
receive an input for specifying a user interest in the one or more offers, the one or more incentives, or a combination thereof based, at least in part, on the one or more exchange rates for the one or more balances of loyalty points as presented.

18. An apparatus of claim 17, wherein the apparatus is further caused to:
process and/or facilitate a processing of one or more computations based on the input to cause, at least in part, a (1) redemption of the one or more loyalty points, the one or more offers, the one or more incentives, or a combination thereof, a (2) comparison of the one or more offers, the one or more incentives, the one or more vendors, or a combination thereof, a (3) purchase of one or more products, or a combination thereof.

19. An apparatus of claim 18, wherein the processing is caused to be performed by the at least one node.

20. An apparatus of claim 11, wherein the loyalty program information includes data for indicating a quantity of product purchases, advertisement views, inquiry responses, focus group participations, incentives used, offers used, loyalty points used, or a combination thereof, in association with the at least one user.
